(19) United States
(12) Patent Application Publication
(10) Pub. No.: US 2015/0368969 A1
(43) Pub. Date: Dec. 24, 2015

(54) NON-DRAWSTRING TYPE CURTAIN RETRACTOR

(71) Applicant: J&J STAMINA ENTERPRISES CO., LTD., KAOHSIUNG CITY (TW)

(72) Inventor: GWO-TSAIR LIN, TAINAN CITY (TW)

(21) Appl. No.: 14/309,998

(22) Filed: Jun. 20, 2014

(51) Int. Cl. E06B 9/76

(52) U.S. Cl. CPC E06B 9/76

(57) ABSTRACT

This invention relates to a curtain retractor without drawstring, which has a retractor major body comprising a mounting seat and a side cover. A transmission rod for coupling with a curtain retracting unit is provided within an accommodation space of the mounting seat. A worm is provided to mesh with a worm gear provided on the transmission rod. Further, the worm is connected with a rotatable rod unit which is to replace conventional drawstring. By implementing the non-drawstring type curtain retractor of the present invention, the accident of children's neck wrapping around by a drawstring, used in conventional curtain structure to roll up and down a fabric, to cause strangulation can be effectively avoided.

### BACKGROUND OF THE INVENTION

1. Field of the Invention

This invention relates to a non-drawstring type curtain retractor, more particularly to a non-drawstring type curtain retractor which can avoid the case of children's neck wrapping around by a drawstring to cause strangulation.

2. Brief Description of the Prior Art

In order to avoid children's neck wrapping around by a drawstring to cause strangulation, each country has developed safety regulations with respect to the drawstring of curtain, for example, a snaps which can be combined or separated is removably provided at the bottom of drawstring. When a child's neck is wrapped around by a drawstring pulled by a force, the snaps at the bottom of the drawstring can be separated so as to relieve from the case of strangulation. However, it often occurs in practical implementation that the snaps is not easy to come off or separate after pulling, or that the combination and separation structure is too complicated to untie the snaps calmly in panic state when a child's neck is wrapped around. Thus, this may result in frequent occurrence of children's strangulation by drawstring.

### SUMMARY OF THE INVENTION

In view of the above shortcomings, the main object of this invention is to provide a non-drawstring type curtain retractor, whereby the occurrence of children's neck wrapping around by a drawstring to cause strangulation can be surely avoided.

In order to achieve above object, the inventor of the present invention proposes a non-drawstring type curtain retractor described as below. The non-drawstring type curtain retractor of the present invention mainly has a retractor major body that comprises a mounting seat and a side cover coupling together, and an accommodation space is provided between the mounting seat and the side cover. Two through holes opposite to each other are formed at the junction of the mounting seat and the side cover, and the two through holes are in communication with the accommodation space. A transmission rod is further provided within the accommodation space one end of which passes through the mounting seat so as to couple with a curtain retracting unit. The other end of the transmission rod has a worm gear and a worm is further provided within the accommodation space, such that teeth of the worm mesh with teeth of the worm gear. One end of the worm extends out through one of the through holes.

When in implementation, a rotatable rod unit is rotated so as to drive the transmission rod through the worm, then the transmission rod rotates a curtain retracting unit so as to conduct rolling up and down of the curtain. By replacing conventional drawstring with the rotatable rod unit of the present invention to pull the curtain, the accident of children's neck wrapping around by a drawstring, used in conventional curtain structure to roll up and down a fabric, to cause strangulation, can be effectively avoided. Furthermore, as through holes are respectively formed at left side and right side of the curtain retraction major body, the worm and the rotatable rod unit can be installed in one of the through holes disposed at outside according to the need to install the curtain retractor of the present invention either at left side or at right side of the curtain rod. Therefore, the benefit of easy manufacturing and implementation can be achieved.

### BRIEF DESCRIPTION OF THE DRAWINGS

FIG. 1 is a perspective exploded view of the present invention.

FIG. 2 is a perspective view of the present invention.

FIG. 3 is a sectional view of the present invention.

FIG. 4 is a perspective exploded view of the rotatable rod of the present invention.

FIG. 5 is a view showing the state in use of the present invention.

### DETAILED DESCRIPTION OF PREFERRED EMBODIMENTS

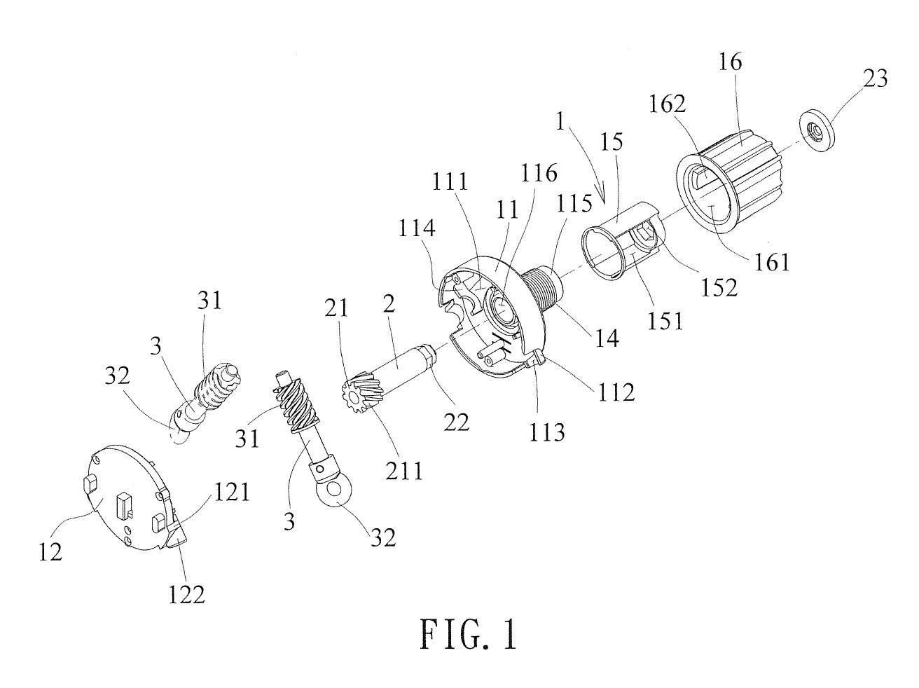

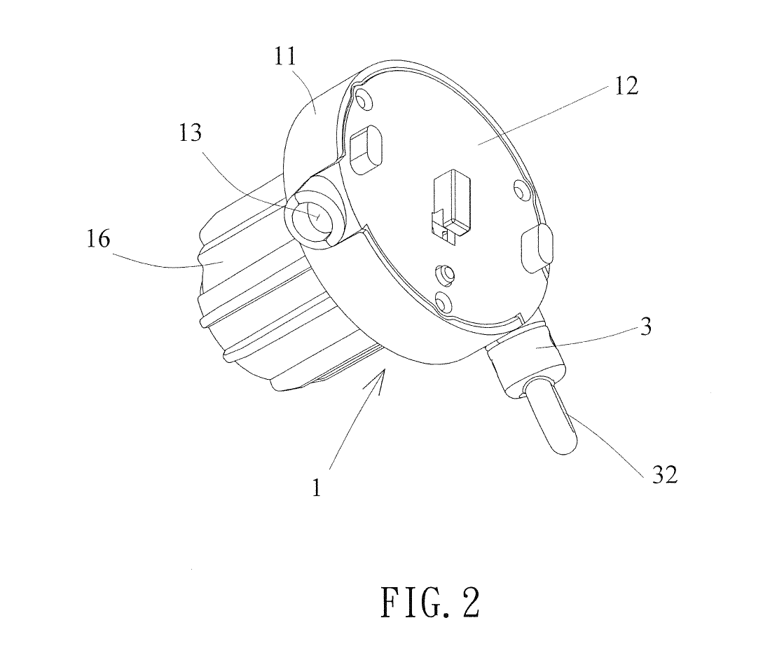

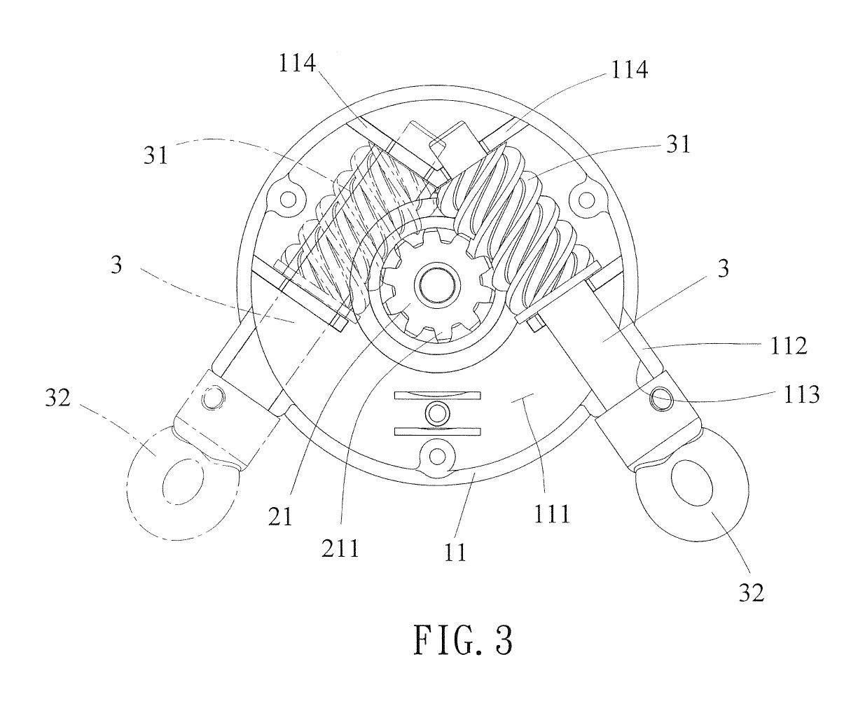

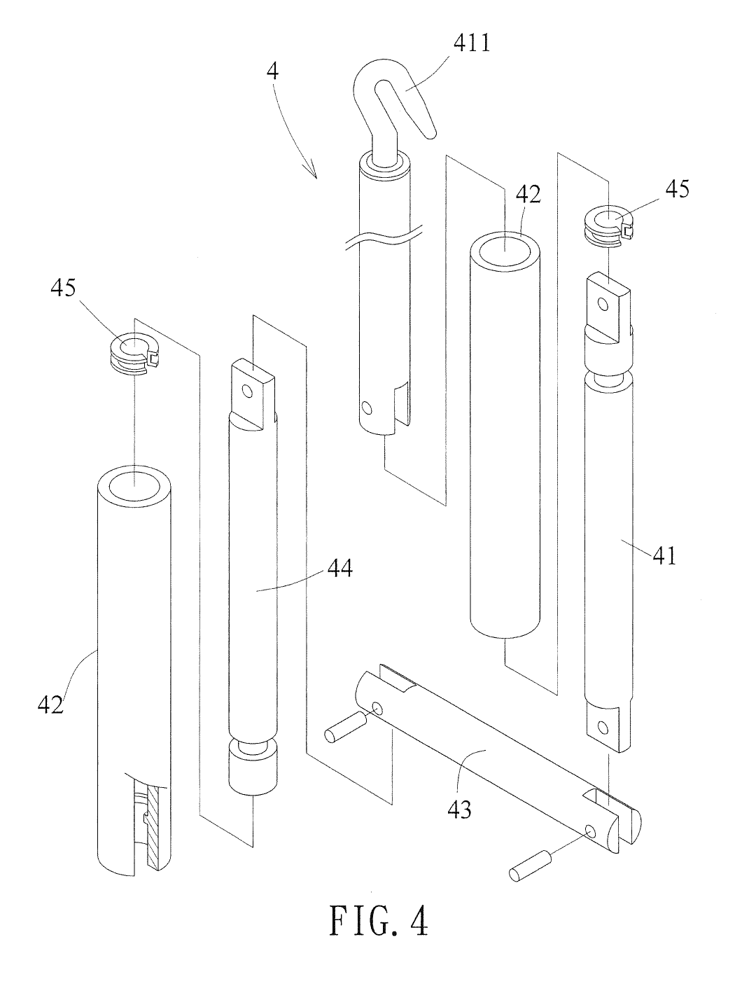

Firstly, referring to FIGS. 1 to 4, a non-drawstring type curtain retractor of the present invention is shown to comprise a retractor major body (1), a transmission rod (2), a worm (3) and a rotatable rod unit (4).

The retractor major body (1) is provided with a mounting seat (11) one end of which is formed with an accommodation space (111). Further, two holding segments (112) are respectively provided at two locations opposite to each other on left side and right side of the mounting seat (11). Each of the two holding segments (112) has an opening (113) communicated with the accommodation space (111). Two side support portions (114) corresponding to the openings (113) of the two holding segments (112) are respectively formed in the accommodation space (111). Further, a side cover (12) is provided to cover the accommodation space (111) and is assembled to the mounting seat (11). Further, two holding segments (121) are respectively provided at two locations opposite to each other on left side and right side of the side cover (12), and each of the two holding segments (121) has an opening (122). The two openings (122) of the holding segments (121) couple with the two openings (113) of the holding segments (112) to form two through holes (13). The mounting seat (11) is provided with a curtain fabric retracting unit at the end opposite to the accommodation space (111). The curtain fabric retracting unit includes an axial rod (115) integrally protruding from the mounting seat (11), and a central bore (116) is provided at the center of the axial rod (115) to communicate with the accommodation space (111). The axial rod (115) has an elastic member (14) fitted thereon, and a bushing (15) is fitted on the axial rod (115) of the mounting seat (11). Two openings (151) are respectively formed at both sides of the bushing (15) so that the end legs of the elastic member (14) may resist against the edges of the openings (151). Further, a polygon shape assembly hole (152) is formed at the end of the bushing (15), and the assembly hole (152) corresponds to the central bore (116) of the axial rod (115). Furthermore, the curtain fabric retracting unit includes an axial cylinder (16), an axial hole (161) of which accommodates the axial rod (115), the bushing (15) and the elastic member (14). Two stopper blocks (162) opposite to each other are provided at the inner wall of the axial hole (161), so that the end legs of the elastic member (14) protruded from the openings (151) of the bushing (15) can resist against the stopper blocks (162).

The transmission rod (2) has a worm gear (21) formed on one end thereof, and a polygon shape assembly portion (22) formed on the other end thereof. The transmission rod (2) is inserted through the central bore (116) of the axial rod (115) of the mounting seat (11), and the polygon shape assembly portion (22) of the transmission rod (2) penetrates to the extent to fit correspondingly with the polygon shape assembly hole (152) of the bushing (15). A fastening member (23) is further provided to fasten the end of the transmission rod (2) extending beyond the axial cylinder (16).

A worm (3) is disposed on the side support portion (114) of the accommodation space (111) of the mounting seat (11), and teeth (31) of the worm (3) meshes with teeth (211) of the worm gear (21) of the transmission rod (2). One end of the worm (3) passes through anyone through hole (13) formed by the coupling of the mounting seat (11) and the side cover (12), and an annular connecting portion (32) is formed at the end portion extending out of the mounting seat (11) and the side cover (12).

The rotatable rod unit (4) has a spindle rod (41) and one end of the spindle rod (41) is combined with a hook type connecting part (411) which is correspondingly to engage with the connecting portion (32) of the worm (3). A sleeve (42) is fitted on the spindle rod (41), and the other end of the spindle rod (41) where the spindle rod (41) is extended out of the sleeve (42) is pivotally connected with one end of a connecting bar (43). The other end of the connecting bar (43) is pivotally connected with a rotatable rod (44) and a sleeve (42) is fitted on the rotatable rod (44). Positioning elements (45) are respectively disposed between the spindle rod (41) and the sleeve (42) and between the rotatable rod (44) and the other sleeve (42), so that the two sleeves (42) are respectively fitted on the spindle rod (41) and the rotatable rod (44) in loose manner.

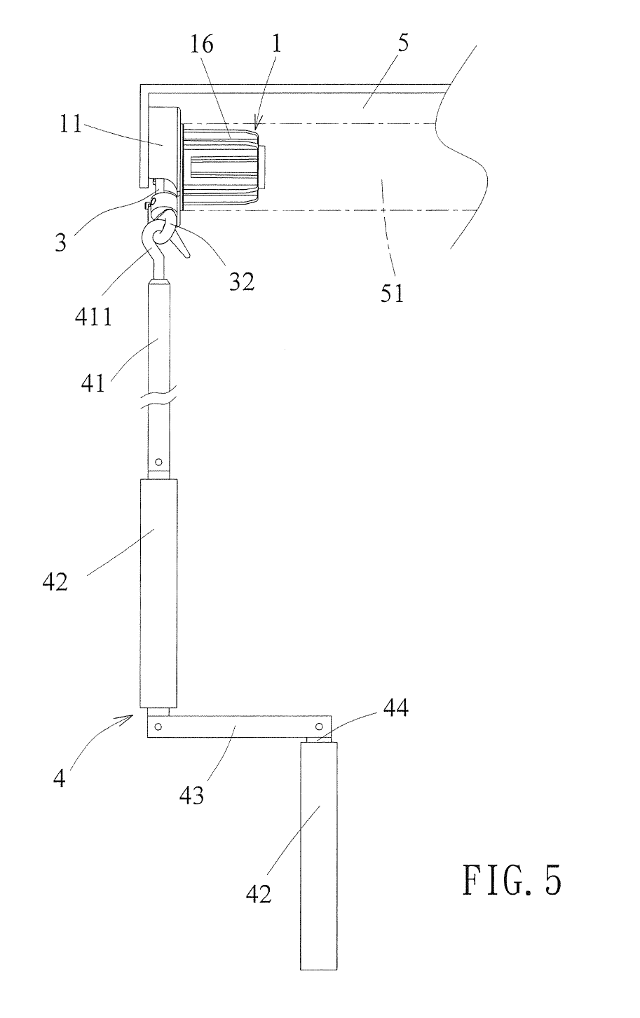

Configuring in this manner, as shown in FIG. 5, the non-drawstring type curtain retractor of the present invention is assembled at one side of a curtain rod (5) in such a manner that the axial cylinder (16) of the retractor major body (1) is fitted on the outside of a curtain reel (51) in the curtain rod (5). A curtain fabric is assembled on the curtain reel (51). Then, a user grips the sleeves (42) respectively on the spindle rod (41) and the rotatable rod (44) with his both hands and applies a force to rotate the rotatable rod, so as to drive the spindle rod (41) through the connecting bar (43), and further to rotate the worm (3) connected with the spindle rod (41). When the worm (3) is driven, the worm gear (21) of the transmission rod (2) meshing with the teeth (31) of the worm (3) is rotated synchronously. Then, the transmission rod (2) drives the bushing (15) together by the engagement between the polygon shape assembly portion (22) formed at one end of the transmission rod (2) and the assembly hole (152) of the bushing (15), and then drives the axial cylinder (16) together by the abutment of the stopper block (162) and the end legs of the elastic member (14) which resist against the openings (151) on both sides of the bushing (15), and finally drives the curtain reel (51) fitted with the axial cylinder (16) to rotate so as to achieve curtain winding.

As the non-drawstring type curtain retractor of the present invention is to conduct curtain winding by rotating the rotatable rod unit (4), which drives the curtain retracting unit, formed by the axial cylinder (16) of the retractor major body (1) etc. . . . , through the worm (3) and the transmission rod (2) so as to rotate the curtain reel (51). In this manner, a curtain fabric retraction embodiment of the present invention having high degree of safety is provided in which the bar type rotatable rod unit (4) is used to replace a drawstring, the accident of children's neck wrapping around by a drawstring, used in curtain structure to roll up and down a fabric, to cause strangulation when pulling the drawstring to play can be effectively avoided.

Furthermore, one thing worth to mention is that the present invention has a left and right through holes (13) formed at the junction of the mounting seat (11) of the retractor major body (1) and the side cover (12). Therefore, when the non-drawstring type curtain retractor of the present invention is installed at the left side of the curtain rod (5), the through hole (13) at the left side of the retractor major body (1) faces outward, so that user in this case is to install the worm (3) in the left side through hole (13), and then to connect the rotatable rod unit (4) and the worm (3) together so as to enable the rolling up and down of the curtain fabric. On the other hand, when the non-drawstring type curtain retractor of the present invention is installed at the right side of the curtain rod (5), the through hole (13) at the right side of the retractor major body (1) faces outward, so that user in this case is to install the worm (3) in the right side through hole (13), and then to connect the rotatable rod unit (4) and the worm (3) together so as to enable the rolling up and down of the curtain fabric. In this manner, the non-drawstring type curtain retractor of the present invention can be either installed at the left side or right side of the curtain rod (5). In this case, manufacturer needs not to open additional die so that manufacturing cost can be lowered. Besides, as the curtain retractor of the present invention can be either installed at the left side or right side of the curtain rod, the curtain retractor can be directly moved to either side without purchasing another curtain retractor having different orientation of the worm (3) when there is a need to change installation side of the curtain retractor. Therefore, economic spending can be saved.

1. A non-drawstring type curtain retractor, having a retractor major body, the retractor major body comprising a mounting seat and a side cover, the mounting seat and the side cover being coupled to each other, an accommodation space being provided between the mounting seat and the side cover, two through holes opposite to each other being formed at the junction of the mounting seat and the side cover, the two through holes being in communication with the accommodation space; a transmission rod being provided within the accommodation space, wherein one end of the transmission rod passes through the mounting seat so as to couple with a curtain fabric retracting unit, the other end of the transmission rod having a worm gear; a worm being further provided within the accommodation space, and teeth of the worm meshing with teeth of the worm gear; one end of the worm extending out through one of the through holes.

2. The non-drawstring type curtain retractor as claimed in claim 1, wherein the non-drawstring type curtain retractor further comprises a rotatable rod unit which is connected with the one end of the worm extending out through one of the through holes of the retractor major body.

3. The non-drawstring type curtain retractor as claimed in claim 2, wherein the rotatable rod unit includes a spindle rod wherein one end of the spindle rod is connected with the one end of the worm extending out through one of the through holes of the retractor major body, and wherein the other end of the spindle rod is pivotally connected with one end of a connecting bar; the other end of the connecting bar is pivotally connected with a rotatable rod; two sleeves are respectively fitted on the outsides of the spindle rod and the rotatable rod; positioning elements are respectively disposed between the spindle rod and the sleeve, and between the rotatable rod and the other sleeve, so that the two sleeves are respectively fitted on the spindle rod and the rotatable rod and are rotatable relative to the spindle rod and the rotatable rod.

4. The non-drawstring type curtain retractor as claimed in claim 1, wherein a first pair of holding segments are respectively provided at two locations opposite to each other on the mounting seat of the retractor major body, and each of the first pair of holding segments has an opening communicated with the accommodation space; two side support portions corresponding to the openings of the two holding segments are respectively formed in the accommodation space for the mounting of the worm; further, a second pair of holding segments are respectively provided at two locations opposite to each other on two sides of the side cover, and each of the second pair of holding segments has an opening, and the two openings of the holding segments of the side cover couple with the two openings of the holding segments of the mounting seat so as to form the two through holes.

5. The non-drawstring type curtain retractor as claimed in claim 4, wherein the non-drawstring type curtain retractor further comprises a rotatable rod unit which is connected with the one end of the worm extending out through one of the through holes of the retractor major body.

6. The non-drawstring type curtain retractor as claimed in claim 5, wherein the rotatable rod unit includes a spindle rod wherein one end of the spindle rod is connected with the one end of the worm extending out through one of the through holes of the retractor major body, and the other end of the spindle rod is pivotally connected with one end of a connecting bar; the other end of the connecting bar is pivotally connected with a rotatable rod; two sleeves are respectively fitted on outsides of the spindle rod and the rotatable rod; positioning elements are respectively disposed between the spindle rod and the sleeve, and between the rotatable rod and the other sleeve, so that the two sleeves are respectively fitted on the spindle rod and the rotatable rod and are rotatable relative to the spindle rod and the rotatable rod.

7. The non-drawstring type curtain retractor as claimed in claim 1, wherein the curtain fabric retracting unit includes: an axial rod extending from the mounting seat, the axial rod having a central bore to communicate with the accommodation space; an elastic member having end legs provided on the axial rod; and a bushing fitted on the axial rod of the mounting seat, the bushing having two openings with edges formed at both sides of the bushing so that the end legs of the elastic member resist against the edges of the openings; a polygon shape assembly hole formed at an end of the bushing, the assembly hole corresponding to the central bore of the axial rod; an axial cylinder an axial hole of which accommodates the axial rod, the bushing and the elastic member, two stopper blocks opposite to each other being provided at the inner wall of the axial hole, so that the end legs of the elastic member protruded from the openings of the bushing resist against the stopper blocks; a polygon shape assembly portion is formed on the end where the transmission rod passes through, and the polygon shape assembly portion passes through the central bore of the axial rod to fit correspondingly with the polygon shape assembly hole of the bushing.

8. The non-drawstring type curtain retractor as claimed in claim 7, wherein the non-drawstring type curtain retractor further comprises a rotatable rod unit which is connected with the one end of the worm extending out through one through hole of the retractor major body.

9. The non-drawstring type curtain retractor as claimed in claim 8, wherein the rotatable rod unit includes a spindle rod wherein one end of the spindle rod is connected with the one end of the worm extending out through one through hole of the retractor major body, and the other end of the spindle rod is pivotally connected with one end of a connecting bar; the other end of the connecting bar is pivotally connected with a rotatable rod; two sleeves are respectively fitted on outsides of the spindle rod and the rotatable rod; positioning elements are respectively disposed between the spindle rod and the sleeve, and between the rotatable rod and the other sleeve, so that the two sleeves are respectively fitted on the spindle rod and the rotatable rod and are rotatable relative to the spindle rod and the rotatable rod.
